(19) United States
(12) Patent Application Publication
(10) Pub. No.: US 2025/0043113 A1
(43) Pub. Date: Feb. 6, 2025

(54) PLANT-DERIVED CROSS-LINKABLE BIOPOLYMER MATERIAL

(71) Applicants: Emmanuel Abraham Ho, Waterloo (CA); Ryan Christopher Nodder, North Bay (CA); Yannick Leandre Traore, Lee, MA (US)

(72) Inventors: Emmanuel Abraham Ho, Waterloo (CA); Ryan Christopher Nodder, North Bay (CA); Yannick Leandre Traore, Lee, MA (US)

(21) Appl. No.: 18/793,355

(22) Filed: Aug. 2, 2024

Related U.S. Application Data
(60) Provisional application No. 63/628,529, filed on Aug. 2, 2023.

(51) Int. Cl. C08L 1/04; C08J 3/24; C08K 5/00; C08K 5/053; C08K 5/092; C08L 89/00

(52) U.S. Cl. CPC C08L 1/04; C08J 3/24; C08K 5/0016; C08K 5/053; C08K 5/092; C08L 89/00

(57) ABSTRACT

Disclosed is a material comprising a soy protein isolate (SPI), an additive and a cellulose, wherein the material is capable of curing through heat or at room temperature to form a solid object. The components of the material are non-cytotoxic, sustainable, and generally regarded as safe (GRAS), and can be used for precise syringe extrusion, after which the resulting product may be solidified using heat. The applications of this material include a potential replacement for the petroleum-based thermoplastics used in extrusion-based 3D printing, and the creation of biodegradable implants and/or drug delivery systems.

### CROSS-REFERENCE TO RELATED APPLICATIONS

This application claims the benefit of U.S. Prov. Pat. App. No. 63/628,529, filed on 3 Aug. 2023, titled: A BIO-BASED PASTE MADE FROM RENEWABLE MATERIALS FOR PACKAGING APPLICATIONS, the entirety of which is hereby incorporated by reference.

### BACKGROUND

### 1. Field of the Discovery

Described herein are plant-protein biopolymer material comprising a plant-protein source that is crosslinked with active agents and a cellulose-base. The material can be 3D printed such as through extrusion printing or molded using a mold, and then cured to a solid. The description also provides methods to prepare said plant-based biopolymer material, as generally and as specifically described herein.

### 2. Background Information

There is a growing problem of environmental pollution worldwide, with paper fibers accounting for a large portion of municipal solid waste. Finding new ways to recycle paper into products is key to reducing the impact of paper waste on environmental pollution. Many of the synthetic plastics used in today's world are petroleum based, which is problematic as they are a major global pollutant, have minimal biodegradability, and are composed of non-renewable resources.

In particular, the industrial 3D printing technology faces a number of obstacles to wide-spread adoption and sustainability. For example, current 3D printing technologies rely on petroleum-based thermoplastics as well as the use of fossil fuel plants to power 3D printers. This has spurred the development of environmentally friendly and biodegradable materials from low-cost or freely available natural and renewable resources.

Soy protein originates from soybeans, which is one of the most abundant plants globally due to their prominent role in the oilseed industry. After harvest, soybeans are separated into oils and meal, after which the meal can be reduced to a protein isolate, a highly concentrated formulation of soy protein consisting of 90-92% protein content. This process involves the defatting of meal, after which leaching of water and alcohol soluble sugars is performed to yield soy protein concentrate. Through further extraction using reprecipitation by alkali and acidification, soy protein isolate is obtained and is the purest version of soy protein. The price of soy protein isolate, the raw material of the invention, is approximately USD $0.90/lb, which is significantly lower than the current market of 3D printing filaments, which range from USD $25-35/lb depending on the material and appearance.

The use of soy protein as a potential bioplastic is well documented, with experiments on its use as a plastic dating back to the early 1930's. The formation of bioplastics from soy protein are reliant on the crosslinking effect between the protein's basic amino acids, which allows for an esterification reaction and the irreversible conjugation of soy protein monomers. Due to the variety of amino acids being present in soy proteins one single interaction is not present, but instead, a variety of reaction between soy protein monomers and formulation additives. Studies conducted on soy proteins have identified methylene crosslinking between basic amino acids such as lysine and arginine as key to protein crosslinking. The addition of crosslinking agents to soy protein plastics further induces crosslinking, as compounds such as hydroxyl agents have been observed to induce crosslinking through hydrogen bonding.

Multiple studies conducted in the last 5 years have begun analyzing the potential for soy protein isolate as a material in the 3D printing of foods. An article published in 2019 displayed the potential for soy protein as the main component of extrusion-based 3D printing, using gelatin to provide a gelling ability for paste-like extrusion of 3D printed products. The resulting material is gelatin-like and squishy, and the aim of this study was to create and evaluate an edible product. Several other studies published on the printability of soy protein isolate use similar techniques for extrusion, and incorporate edible additives such as sodium alginate, xanthan gum, wheat gluten, cocoa butter and more. The limitations of these studies are the narrow focus on edible and food-based products. However, the assessment of the potential of soy protein for bioplastics for 3D printing has received little-to-no attention.

The use of plant-derived materials in 3D printing technologies would benefit greatly due to their low toxicity, high biodegradability, renewability, and improved recycling options. Thus, there is a continued need in the art for environmentally friendly, non-toxic materials for 3D printing.

### SUMMARY

Described herein is a paste-like material comprising a soy protein isolate (SPI), an additive, and a cellulose source, wherein the material is capable of curing, either through heat or at room temperature, to produce a solid object. The components of the material are non-cytotoxic, sustainable, and generally regarded as safe (GRAS). As the material is paste-like, it has the potential for precise syringe extrusion after which the resulting product may be solidified using heat. The material is a potential replacement for the petroleum-based thermoplastics used in extrusion-based 3D printing. Additionally, the material can be used to create biodegradable implants and/or drug delivery systems.

The proposed invention allows for the creation of a novel biomaterial that is based on recycled material, composed of generally regarded as safe (GRAS) components and absent of the use of petroleum based materials. This material relies on the induction of protein crosslinking using a protein component with formulation additives and crosslinking agents, combined with a cellulose base to create a paste with the potential for syringe extrusion and heat-catalyzed curing. Some of the significant outcomes that may result from the synthesis of this material include a lower power consumption and petroleum free alternative to FDM, the development of a naturally biodegradable material that incorporates the recyclability of paper, and the potential for medical applications such as scaffold development or biodegradable implants.

Described herein is a bio-based curable material comprising a plant-derived protein, an additive, and a cellulose, wherein the material is capable of curing, either through heat or at room temperature, to produce a solid object.

Further described herein is a method of making a bio-based curable material comprising: (a) preparing a plant-derived protein solution, (b) preparing an additive solution, (c) preparing a cellulose solution, and combining (a)-(c) to form a final binder solution.

The preceding general areas of utility are given by way of example only and are not intended to be limiting on the scope of the present disclosure and appended claims. Additional objects and advantages associated with the compositions, methods, and processes of the present invention will be appreciated by one of ordinary skill in the art in light of the instant claims, description, and examples. For example, the various aspects and embodiments of the invention may be utilized in numerous combinations, all of which are expressly contemplated by the present description. These additional advantages objects and embodiments are expressly included within the scope of the present invention. The publications and other materials used herein to illuminate the background of the invention, and in particular cases, to provide additional details respecting the practice, are incorporated by reference.

### BRIEF DESCRIPTION OF THE DRAWINGS

The accompanying drawings, which are incorporated into and form a part of the specification, illustrate several embodiments of the present disclosure; and, together with the description, serve to explain the principles of the disclosure. The drawings are only for the purpose of illustrating an embodiment of the invention and are not to be construed as limiting the disclosure. Further objects, features and advantages of the disclosure will become apparent from the following detailed description taken in conjunction with the accompanying figures showing illustrative embodiments of the invention, in which:

FIG. 1. Illustrates a flowchart for the development of an exemplary CSBP paste as described herein.

FIG. 2. Demonstrates a summary of CSBP Synthesis

FIG. 3 A heat cured CSBP object

FIGS. 4A and 4B. Successful 3D Printing of CSBP Illustrated 3D printed structures that were created using a FlexiFood single head 3D printer and the exemplary CSBP paste

FIGS. 5A, 5B, 5C, and 5D. Illustrate an SEM of Soy Protein Isolate and Microcrystalline Cellulose. (A) SEM of Soy Protein Isolate; (B) SEM of Microcrystalline Cellulose; (C) SEM of CSBP at 5.0 kx magnification; (D) SEM of CSBP at 1 kx magnification.

FIG. 6. Rheology of CSBP for 3D Printing. Shear rates were recorded from 0.1 to 1000 s-Â.

FIG. 7. Comparison of CSBP Tensile Strength by Self-curing Duration and Relative Humidity. **p<0.01, ***p<0.001. ****p<0.0001. Data represents the mean+/−SD (n=3).

FIGS. 8A and 8B. Comparison of CSBP Compressive Strength by Curing Time and Humidity. (A) 10% deformation compressive strength of CSBP. (B) 35% deformation compressive strength of CSBP. **p<0.01, ***p<0.001, ****p<0.0001. Data represents the mean+/−SD (n=3).

FIGS. 9A and 9B. Soil Biodegradation of Self-cured CSBP. (A) Percent mass remaining of selfcured CSBP over a period of 80 days. (B) Weekly degradation rate of self-cured CSBP samples, expressed as a percentage. Error bars smaller than the data point symbols are not shown.

FIG. 10. Comparison of Self-cured CSBP Soil Biodegradation to Other Thermoplastics (Control, left; ABS, second from left; PLA, second from right; CSBP, right). Comparative mass remaining after 80 days of soil burial for PLA, ABS and CSBP with control. Data represented is the mean+/−SD (n=3).

FIG. 11. Comparison of CSBP Mechanical Properties by Curing Condition. The comparison between compressive strength is not direct, and instead between compressive strength at 35% deformation for self-cured CSBP and compressive strength of heat cured CSBP. **p<0.01, ****p<0.0001.

FIG. 12. Comparison of water uptake by Curing Condition.

FIGS. 13A and 13B. Water contact angle by Curing Condition.

### DETAILED DESCRIPTION

Described herein is a biomaterial based on recycled material, composed of generally regarded as safe (GRAS) components and absent of the use of petroleum based materials. This material relies on the induction of protein crosslinking using a protein component with formulation additives and crosslinking agents, combined with a cellulose base to create a paste with the potential for syringe extrusion and heat-catalyzed curing. Some of the significant outcomes that may result from the synthesis of this material include a lower power consumption and petroleum free alternative to fused deposition modeling (FDM), the development of a naturally biodegradable material that incorporates the recyclability of paper, and the potential for medical applications such as scaffold development or biodegradable implants.

Thus, in one aspect, the description provides a paste-like material comprising plant-derived protein source, an additive, and a cellulose, wherein the material is capable of curing, either through heat or at room temperature, to produce a solid object. In any of the aspects or embodiments described herein, the plant-derived protein source is a soy protein isolate (SPI).

In any of the aspects or embodiments described herein, the components of the material are non-cytotoxic, sustainable, and generally regarded as safe (GRAS). As the material is paste-like, it has the potential for precise syringe extrusion after which the resulting product may be solidified using heat. The material is a potential replacement for the petroleum-based thermoplastics used in extrusion-based 3D printing.

In an additional aspect, the description provides a biodegradable medical implant comprising the material as described herein.

In an additional aspect, the description provides a drug delivery system comprising the material as described herein.

While various embodiments of the present disclosure are described herein, it will be understood by those skilled in the art that such embodiments are provided by way of example only. It will be understood by those skilled in the art that numerous modifications and changes to, and variations and equivalent substitutions of, the embodiments described herein can be made without departing from the scope of the disclosure. It is understood that various alternatives to the embodiments described herein may be employed in practicing the disclosure, and modifications may be made to adapt a particular structure or material to the teachings of the disclosure. It is also understood that every embodiment of the disclosure may optionally be combined with any one or more of the other embodiments described herein which are consistent with that embodiment.

Where elements are presented in list format (e.g., in a Markush group), it is understood that each possible subgroup of the elements is also disclosed, and any one or more elements can be removed from the list or group.

It is also understood that, unless clearly indicated to the contrary, in any method described or claimed herein that includes more than one act or step, the order of the acts or steps of the method is not necessarily limited to the order in which the acts or steps of the method are recited, but the disclosure encompasses embodiments in which the order is so limited.

It is further understood that, in general, where an embodiment in the description or the claims is referred to as comprising one or more features, the disclosure also encompasses embodiments that consist of, or consist essentially of, such feature(s).

It is also understood that any embodiment of the disclosure, e.g., any embodiment found within the prior art, can be explicitly excluded from the claims, regardless of whether the specific exclusion is recited in the specification.

Headings are included herein for reference and to aid in locating certain sections. Headings are not intended to limit the scope of the embodiments and concepts described in the sections under those headings, and those embodiments and concepts may have applicability in other sections throughout the entire disclosure.

All patent literature and all non-patent literature cited herein are incorporated herein by reference in their entirety to the same extent as if each patent literature or non-patent literature were specifically and individually indicated to be incorporated herein by reference in its entirety.

Unless otherwise defined, all technical and scientific terms used herein have the same meaning as commonly understood by one of ordinary skill in the art to which this disclosure belongs.

Where a range of values is provided, it is understood that each intervening value between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding both of those included limits are also included in the invention.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The term “exemplary” as used herein means “serving as an example, instance or illustration”. Any embodiment or feature characterized herein as “exemplary” is not necessarily to be construed as preferred or advantageous over other embodiments or features.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. Likewise, in a similar vein, the phrase “and the like” when included as part of a list is intended to convey that while the list is inclusive it is not necessarily exhaustive but those of skill in the art recognizing the guideposts provided in the listing have no problems recognizing specific compounds that fit within the more broadly disclosed classes. The phrase “and the like” explicitly recognizes those molecules and compounds, often too numerous to list, that fit within the disclosed parameters.

It should also be understood that, in certain methods described herein that include more than one step or act, the order of the steps or acts of the method is not necessarily limited to the order in which the steps or acts of the method are recited unless the context indicates otherwise.

The term “about” or “approximately” means an acceptable error for a particular value as determined by one of ordinary skill in the art, which depends in part on how the value is measured or determined. In certain embodiments, the term “about” or “approximately” means within one standard deviation. In some embodiments, when no particular margin of error (e.g., a standard deviation to a mean value given in a chart or table of data) is recited, the term “about” or “approximately” means that range which would encompass the recited value and the range which would be included by rounding up or down to the recited value as well, taking into account significant figures. In certain embodiments, the term “about” or “approximately” means within 10% or 5% of the specified value. Whenever the term “about” or “approximately” precedes the first numerical value in a series of two or more numerical values or in a series of two or more ranges of numerical values, the term “about” or “approximately” applies to each one of the numerical values in that series of numerical values or in that series of ranges of numerical values.

Whenever the term “at least” or “greater than” precedes the first numerical value in a series of two or more numerical values, the term “at least” or “greater than” applies to each one of the numerical values in that series of numerical values.

Whenever the term “no more than” or “less than” precedes the first numerical value in a series of two or more numerical values, the term “no more than” or “less than” applies to each one of the numerical values in that series of numerical values.

Described herein is a bio-based curable material comprising a plant-derived protein, an additive, and a cellulose, wherein the material is capable of curing, either through heat or at room temperature, to produce a solid object.

In any aspect or embodiment described herein, the plant-derived protein comprises a hydrophilic plant protein. In any aspect or embodiment described herein, the plant-derived protein comprises a soy protein source (e.g., soy flour, defatted soy flour, soy concentrate, soy protein isolate (SPI), or a combination thereof), a pea protein source (e.g., pea flour, defatted pea flour, pea concentrate, pea protein isolate, or a combination thereof), a lupin protein source (e.g., lupin flour, defatted lupin flour, lupin concentrate, lupin protein isolate, or a combination thereof), a pumpkin seed protein source (e.g., pumpkin seed flour, defatted pumpkin seed flour, soy concentrate, pumpkin seed protein isolate, or a combination thereof), a whey protein source (e.g., whey flour, defatted whey flour, whey concentrate, whey protein isolate, or a combination thereof), a casein protein source (e.g., casein flour, defatted casein flour, casein concentrate, casein protein isolate, or a combination thereof), a zein protein source (e.g., zein flour, defatted zein flour, zein concentrate, zein protein isolate, or a combination thereof), or a combination thereof. In any aspect or embodiment described herein, the plant-derived protein comprises a soy protein source including at least one of soy flour, defatted soy flour, soy concentrate, soy protein isolate, or a combination thereof.

In any aspect or embodiment described herein, the plant-derived protein comprises from about 40 wt % to about 90 wt % protein. In any aspect or embodiment described herein, the soy protein source comprises from about 40 wt % to about 90 wt % protein.

In any aspect or embodiment described herein, the plant-derived protein is mixed with water to form a plant protein solution at from about 10% w/v to about 30% w/v (e.g., about 20% w/v). In any aspect or embodiment described herein, the soy protein source is mixed with water to form a soy protein solution at from about 10% w/v to about 30% w/v. In any aspect or embodiment described herein, the soy protein solution is about 20% w/v.

In any aspect or embodiment described herein, the soy protein is denatured by heating the soy protein solution to about 70° C. to about 90° C. for at least about 10 minutes (e.g., about 10 minutes to about 360 minutes, about 15 minutes to about 60 minutes, or about 20 minutes).

In any aspect or embodiment described herein, the plant-derived protein is crosslinked.

In any aspect or embodiment described herein, the additive comprises at least one of a cross-linking agent, a plasticizer, or a combination thereof.

In any aspect or embodiment described herein, the cross-linking agent has at least one of a hydroxyl group, a carboxyl group, or a combination thereof. In any aspect or embodiment described herein, the cross-linking agent is glycerol, polyol, polyol derivatives, sorbitol, propylene glycol, polyethylene glycol (PEG) of varying molecular weight, triethylene glycol (TEG), polyvinyl alcohol (PVA), citric acid, malic acid, succinic acid, fumaric acid, tannic acid, glutaric acid, a carboxyl compound, formaldehyde, genipin, glutaraldehyde, or a combination thereof. In any aspect or embodiment described herein, the cross-linking agent is citric acid.

In any aspect or embodiment described herein, the cross-linking agent is mixed with water to form an additive solution with cross-linking agent at from about 15% w/v to about 70% w/v. In any aspect or embodiment described herein, the citric acid is mixed with water to form an additive solution comprising citric acid at from about 50% w/v to about 70% w/v. In any aspect or embodiment described herein, additive solution comprises citric acid at about 60% w/v.

In any aspect or embodiment described herein, the cross-linking agent is glycerol. In any aspect or embodiment described herein, the glycerol is mixed with water to form an additive solution comprising glycerol at from about 15% w/v to about 35% w/v. In any aspect or embodiment described herein, the additive solution comprises glycerol at about 25% w/v.

In any aspect or embodiment described herein, the plasticizer is mixed with water to form an additive solution comprising plasticizer at from about 5% w/v to about 15 w/v.

In any aspect or embodiment described herein, the plasticizer is an ethylene glycol-based compound, pectin, tannins (e.g., gallic acid, catechins, or a combination thereof), formaldehyde, genipin, glutaraldehyde, or a combination thereof. In any aspect or embodiment described herein, the plasticizer is an ethylene glycol-based compound. In any aspect or embodiment described herein, the ethylene glycol-based compound comprises at least one of an ethylene glycol, triacetin, triethylene glycol, a polyethylene glycol, or a combination thereof.

In any aspect or embodiment described herein, the material comprises a ratio of plant-derived protein to additive of about 1:1.2.

In any aspect or embodiment described herein, the cellulose comprises paper fibers, paper pulp, microcrystalline cellulose, microcrystalline cellulose, cellulose nanocrystals, cellulose nanofibers, cellulose derivatives (e.g., methyl cellulose, hydroxyethyl cellulose, carboxylmethyl cellulose, paper pulp, or a combination thereof. In any aspect or embodiment described herein, the cellulose comprises paper fibers, paper pulp, microcrystalline cellulose, or a combination thereof.

In any aspect or embodiment described herein, the material comprises a ratio of plant-derived protein to cellulose of about 1:2 to about 1:5.

Further described herein is a method of making a bio-based curable material comprising: (a) preparing a plant-derived protein solution, (b) preparing an additive solution, (c) preparing a cellulose solution, and combining (a)-(c) to form a final binder solution.

In any aspect or embodiment described herein, the step of preparing the plant-derived protein solution comprises mixing a plant-derived protein and water to form a plant-derived protein solution at from about 10% w/v to about 30% w/v.

In any aspect or embodiment described herein, the plant-derived protein comprises a hydrophilic plant protein. In any aspect or embodiment described herein, the plant-derived protein comprises a soy protein source (e.g., soy flour, defatted soy flour, soy concentrate, soy protein isolate (SPI), or a combination thereof), a pea protein source (e.g., pea flour, defatted pea flour, pea concentrate, pea protein isolate, or a combination thereof), a lupin protein source (e.g., lupin flour, defatted lupin flour, lupin concentrate, lupin protein isolate, or a combination thereof), a pumpkin seed protein source (e.g., pumpkin seed flour, defatted pumpkin seed flour, soy concentrate, pumpkin seed protein isolate, or a combination thereof), a whey protein source (e.g., whey flour, defatted whey flour, whey concentrate, whey protein isolate, or a combination thereof), a casein protein source (e.g., casein flour, defatted casein flour, casein concentrate, casein protein isolate, or a combination thereof), a zein protein source (e.g., zein flour, defatted zein flour, zein concentrate, zein protein isolate, or a combination thereof), or a combination thereof. In any aspect or embodiment described herein, the plant-derived protein is soy protein. In any aspect or embodiment described herein, the soy protein comprises at least one of soy flour, defatted soy flour, soy concentrate, soy protein isolate (SPI), or a combination thereof.

In any aspect or embodiment described herein, the step of preparing an additive solution comprises mixing at least one of a cross-linking agent, a plasticizer or a combination thereof with water to form an additive solution.

In any aspect or embodiment described herein, the cross-linking agent is present in an amount of from about 15% w/v to about 70% w/v.

In any aspect or embodiment described herein, the cross-linking agent has at least one of a hydroxyl group, a carboxyl group or a combination thereof.

In any aspect or embodiment described herein, the cross-linking agent is glycerol, polyol, polyol derivatives, sorbitol, propylene glycol, polyethylene glycol (PEG) of varying molecular weight, triethylene glycol (TEG), polyvinyl alcohol (PVA), citric acid, malic acid, succinic acid, fumaric acid, tannic acid, glutaric acid, a carboxyl compound, formaldehyde, genipin, glutaraldehyde, or a combination thereof.

In any aspect or embodiment described herein, the cross-linking agent is citric acid. In any aspect or embodiment described herein, the citric acid is present in an amount of from about 50% w/v to about 70% w/v. In any aspect or embodiment described herein, the citric acid is present in an amount of about 60% w/v.

In any aspect or embodiment described herein, the cross-linking agent is glycerol. In any aspect or embodiment described herein, the glycerol is present in an amount of from about 15% w/v to about 35% w/v. In any aspect or embodiment described herein, the glycerol is present in an amount of about 25% w/v.

In any aspect or embodiment described herein, the plasticizer is present at an amount of from about 5% w/v to about 15 w/v.

In any aspect or embodiment described herein, the plasticizer is an ethylene glycol-based compound, pectin, tannins (e.g., gallic acid, catechins, or a combination thereof), formaldehyde, genipin, glutaraldehyde, or a combination thereof. In any aspect or embodiment described herein, the plasticizer is an ethylene glycol-based compound. In any aspect or embodiment described herein, the ethylene glycol-based compound comprises at least one of an ethylene glycol, triacetin, triethylene glycol, a polyethylene glycol or a combination thereof.

In any aspect or embodiment described herein, the material comprises a ratio of plant-derived protein solution to additive solution of about 1:1.2.

In any aspect or embodiment described herein, the material comprises a ratio of plant-derived protein solution to cellulose solution of about 1:2 to about 1:5.

In any aspect or embodiment described herein, the method further comprises a step of 3D printing or extruding the material and optionally curing with heat or an enzyme.

The cellulose component of CSBP serves as an emulsifier or filler and may be any type of paper such as white or brown, as well as other types of paper fibers and materials containing cellulose. To recycle paper into its formulation, CSBP requires the paper be processed into a powder. This involves the use of a cryogenic mill to induce the grinding and subsequent powdering of paper, however, other methods such as thermos-mechanical pulping can also process paper into a powder for use in the CSBP formulation. Beyond paper, other cellulose sources such as MCC (used all throughout this study) and paper pulp can be substituted for the cellulose component of the material. Other than cellulose, other emulsifiers such as xanthan gum, gelatin and clay powder can also be used in lieu of a cellulose-based emulsifier. In certain embodiments described herein, the cellulose-based protein biopolymer material, e.g., cellulose-based soy protein biopolymer (CSBP) material, use microcrystalline cellulose (MCC) for the cellulose component. In other embodiments, other forms of cellulose and non-cellulose filler material, e.g., clay powder, powdered brown paper, gelatin, or xanthan gum, are used in order to tune the properties of the material.

Unlike most polymers in which monomers undergo a reaction to yield a crystalline and/or consistent crosslinked structure with a specific mechanism, the crosslinking of soy protein as used in CSBP is amorphous and relies on multiple crosslinking mechanisms commonly used in soy protein-based biomaterials. Firstly, soy protein can form crosslinks with itself, however, this process is scarcely spontaneous, and denaturation is needed to unfold soy protein and expose more functional groups. Soy protein self-crosslinking with disulfide bonds is a common redox reaction and results from the oxidation of sulfhydryl groups on the soy protein's cysteine residues, resulting in the formation of a S—S bond. Disulfide bond formation is a major contributor to overall protein structure and occurs spontaneously during protein folding, therefore, the denaturation of protein is a useful step to initiate self-crosslinking.

Relying on denatured soy protein self-crosslinking with disulfide bonds in its own would produce a final product with a very low degree of crosslinking, so, additional crosslinking agents were added to the CSBP formulation. Glycerol is a non-toxic, naturally occurring triol, and has been used by previous researchers as a plasticizer for soy protein-based films. As a hydroxyl crosslinking agent, glycerol reacts with amino groups present on amino acids such as lysine and arginine to form a covalent bond between soy protein monomers. In addition to glycerol, citric acid is another non-toxic naturally occurring crosslinking agent that interacts with amino groups and was incorporated into the CSBP formulation. As determined by studies conducted by Xu et al., the citric acid crosslinking mechanism is a nucleophilic substitution with a carboxyl group on citric acid and a free amine group (lysine, arginine) to form a new amide bond. The two crosslinking agents included in the CSBP formulation, citric acid and glycerol, can undergo crosslinking reactions in the presence of denatured soy protein's exposed functional groups to form a polymer network, and have each been used by previous researchers looking to increase the mechanical properties of SPI-based materials. The three crosslinking mechanisms mentioned are integral to the self-curing of CSBP, however, CSBP may also be crosslinked using heat.

### Examples

Soy Protein Isolate (92% protein content) is commercially available from MP Biomedicals. Citric Acid (>99.5%), glycerol (>99%), microcrystalline cellulose (microcrystalline powder, 20 m), carnauba wax (refined), fluorescein sodium salt, polyvinyl alcohol is commercially available from Sigma Aldrich Canada. Promega CellTiter 96™ AQueous One Solution Cell Proliferation Assay (MTS), 0.25% trypsin-EDTA was purchased from Thermo Fischer. Heat-inactivated fetal bovine serum (FBS), penicillin/streptomycin 100×, and 0.4% trypan blue was purchased from Fischer Scientific.

### Preparation of Plant Protein Component

In an exemplary embodiment, the material as described herein is produced by first creating the plant protein component of the formulation. Multiple food protein sources (e.g., hydrophilic plant proteins, soy protein, pea protein, lupin protein, pumpkin seed protein, whey protein, casein, zein, or a combination thereof) can be used, however, this example will outline the use of soy protein isolate (SPI) as a source of protein crosslinking. Multiple sources of soy protein can be used for the protein component of the formulation, which include but are not limited to soy flour, defatted soy flour, soy concentrate and soy protein isolate, which each having a different protein composition ranging from 40-90% protein. Soy protein powder is mixed to create a mixture of about 20% w/v soy protein solution with deionized water, although w/v ranges between about 10% w/v to about 30% w/v can also be used. From here, a denaturation step may be performed, and the soy protein solution may be heated to about 700° C. to about 90° C. (e.g., about 75° C.) for at least about 15 minutes (e.g., about 15 minutes to about 360 minutes, about 15 minutes to about 60 minutes, or about 20 minutes) to expose more functional groups to crosslinking. Other forms of protein denaturation such as the use of pH (e.g., pH of about 2.5 to about 3.5 or about 9.5 to about 12) or enzymes (e.g., protease, peptidase, pepsin, papain, trypsin, alcalase, or a combination thereof) may be implemented as well or in place of heat.

### Preparation of Formulation Additives

A combination of additives, such as crosslinking agents (e.g., glycerol, polyol, polyol derivatives, sorbitol, propylene glycol, polyethylene glycol (PEG) of varying molecular weight, triethylene glycol (TEG), polyvinyl alcohol (PVA), citric acid, malic acid, succinic acid, fumaric acid, tannic acid, glutaric acid, a carboxyl compound, formaldehyde, genipin, glutaraldehyde, or a combination thereof), are dissolved in solution to prepare the active component to be used with the protein crosslinking component in step 1. As protein binders rely on esterification reactions between amino groups, the addition of crosslinking agents works to increase the interactions between the proteins and itself. For this, a hydroxyl and carboxyl containing compound may be used to act as a crosslinking agent. For the carboxyl component, citric acid may be used and dissolved in a ratio of about 60% w/v with deionized water, with a range of about 50% w/v to about 70% w/v also being suitable for use of a carboxyl component. Several other compounds with active carboxyl groups can be substituted for citric acid and used instead. A hydroxyl compound such as glycerol is used at about 25% w/v as a crosslinking agent and is added to the carboxyl component solution and may be used in a ratio of from about 15% w/v to about 35% w/v ratio. Other compounds containing hydroxyl groups such as sorbitol may also be used in the formulation in lieu of glycerol.

In certain embodiments, additional additives are added to the formulation to change the resulting properties of the product. Additives are compounds that are selectively introduced in the manufacturing of materials to change their properties. For example, in certain embodiments, the formulation of the material as described herein includes a plasticizer. A study reviewing the use of plasticizers on protein-based materials has identified many of the compounds used to change the mechanical properties of protein-based materials, Ullsten, N. H., et al. Plasticizers for Protein-Based Materials. In Viscoelastic and Viscoplastic Materials; IntechOpen, 2016, which is incorporated herein by reference for all purposes. For soy protein, ethylene glycol-based compounds are often used as a plasticizer to increase the strength of the material by inserting within the polymer chain. A mixture ethylene glycol-based compounds such as triethylene glycol (C₆H₁₄O₄) and polyethylene glycol (PEG) 6000 may be used in quantities of 5-15% w/v respectively to increase the resulting mechanical properties. Other ethylene glycol compounds such as PEG of different molecular weight, ethylene glycol, triacetin and more structurally related compounds may be used instead, as well as other known plant-protein additives (e.g., pectin, tannins (such as, gallic acid, catechins, or a combination thereof), formaldehyde, genipin, glutaraldehyde, or a combination thereof).

With all the selected additives, which may or may not include crosslinking agents containing active hydroxyl and carboxyl groups and other formulation additives together, the addition of deionized water may be used to help dissolve all the components according to the w/v ratios used.

### Combination of Final Binder

The protein component prepared in step 1 is added to the formulation additives used in step 2. A mixture of protein component to additives is used in a 1:1.2 optimal ratio of protein component to formulation additive to create a final binder solution.

### Preparation of Cellulose Base

The second component of this material is the use of a cellulose base to use in combination with the binder to create the cellulose-based soy biopolymer paste. The cellulose material used may be a type of paper such as white or brown, as well as other types of paper fibers and materials containing cellulose. Alternatively, other cellulose sources such as microcrystalline cellulose, cellulose nanocrystals, cellulose nanofibers, cellulose derivatives (e.g., methyl cellulose, hydroxyethyl cellulose, carboxylmethyl cellulose, or a combination thereof), paper pulp, and more may be used for this component of the material.

For the use of paper as the cellulose component of this material, the paper is powdered prior to its use in the formulation. This can involve the use of a cryogenic mill to induce the cryogenic grinding and subsequent powdering of paper. Other methods of powdering paper such as thermo-mechanical pulping (TMP) may be used to produce the cellulose base to be used in this material. Alternatively, microcrystalline cellulose can be used as a cellulose source in place of powdered paper.

### Final Preparation of Material

For the final step in the synthesis of the material, the final binder created in step 3 is combined with the cellulose component created in step 4. The protein component can be integrated with the cellulose component in a 1:2 to 1:5 ratio to create the final product, and ratio used will alter the resulting properties and viscosity of the paste. A ratio of 1 g white powdered paper to 4 g final binder, or 1 g brown powdered paper to 4.5 g final binder is optimal for a paste with viscosity for consistent syringe extrusion. The final product is a self-curable paste capable of heat catalyzed curing.

### Curing of CSBP Paste

Once CSBP paste has been produced, it can undergo self-curing using to form a solid, final object without the use of heat or any additional catalysts. However, this process is reductive in nature due to both the loss of DI water by evaporation and the SPI film formation around MCC fibers.

Although having self-curing properties and capable of solidification at room temperature and humidity, the synthesized cellulose-based plant biopolymer (CPBP) paste, for example, a cellulose-based soy biopolymer (CSBP), is capable of heat-catalyzed conjugation to form a final solid product although not necessary to obtain a fully solid object. In certain aspects the curing of CPBP paste is achieved using a temperature of about 1400° C. to about 2100° C. (e.g., about 200° C.) for about 5 minutes to about 60 minutes (e.g., about 20 minutes) to fully solidify the CSBP. The exact heat curing time depends on the dimensions of the object being heat cured due to the need for heat penetration throughout the entire CSBP structure.

The curing temperature and time applied to the CSBP can be changed and used to alter the desired resulting properties of the material, as combinations of lower heat and time allow for a more elastic and softer object to be formed. The exact heat curing time depends on the dimensions of the object being heat cured due to the need for heat penetration throughout the entire CSBP structure. CSBP samples were observed every 5 minutes of heat curing, to observe browning and ensure no pyrolysis of the sample.

The curing temperature and time applied to CSBP can be used to tune the desired end properties of the material, as the use of high temperature heat curing creates a more rigid object. Heat cured variation of CSBP can be applied to create a stronger and more water-resistant final product. For this, CSBP paste is printed and placed into a lab oven at 200° C. for 20-60 minutes depending on the sample dimensions, for the induction of the Maillard reaction.

With the visible production of melanoidins as well as a distinct baking aroma that occurs during heat curing, it is evident that the Maillard reaction is taking place when heat curing CSBP. However, the CSBP formulation was not originally intended to produce Maillard-type reactions when heat cured, as the formulation consists of none of the typical reducing sugars that are needed for their carbonyl groups. It is presumed then that the presence of reducing sugars needed for Maillard-type reactions in heat cured CSBP may be a result of the thermal degradation of citric acid and glycerol, which can form reactive carbonyl-containing compounds in their degradation pathways. The thermal degradation of glycerol produces multiple reactive aldehyde and ketone-containing compounds, while citric acid may degrade into aconitic acid then acetone, which contains a carbonyl group. Although neither of these decomposition products fit the typical description of a reducing sugar such as glucose and fructose, the presence of these carbonyl compounds may still facilitate the Maillard reaction or react with each other to form other unknown compounds that contribute to the Maillard reaction.

### Results

### 3D Printing

CSBP paste was prepared according to the process outlined in section 2.2. Once prepared, CSBP paste was thoroughly mixed before being loaded into a 100 mL syringe and placed into a FelixFood 3D printer. Objects to be printed were designed with SOLIDWORKS and sliced on Simplify3D using a printer profile designed for the FelixFood 3D printer. The optimized 3D printing settings of CSBP are as follows:

TABLE
Optimized Printing Parameters for CSBP Using a Syringe-based 3D Printer

| 3D Printing Parameter | Value | | Definition |
|---|---|---|---|
| Nozzle Diameter | 1.03 mm | (18Ga) | Diameter of extruded nozzle |
| Layer Height | 0.50 | mm | Thickness of each printed layer |
| Extrusion Multiplier | 0.95 | | Multiplier for all extrusion movements. |
| | | | Used for flowrate tweaking |
| Retraction Distance | 1.0 | mm | How much material to pull back into |
| | | | nozzle |
| Extra Restart Distance | 0.04 | mm | Extra extrusion distance on top of initial |
| | | | retraction amount |
| Retraction Vertical Lift | 0.50 | mm | Distance nozzle will life from surface of a |
| | | | part during a retraction move |
| Retraction Speed | 300 | mm/min | Extruded speed for retraction movements |
| Coating Distance | 1.25 | mm | Distance nozzle will stop extruding prior to |
| | | | the end of a loop |
| Wipe Distance | 2.0 | mm | Total distance for wipe movement |

| First Layer Height | 200% | Height of first printed layer. Remaining |
|---|---|---|
| | | layers are 100% height |
| Outline Overlap | 50% | Percentage of extrusion width that will |

overlap with outline perimeter. Used to
ensure infill bonds to outline

A consistent flowrate was established using the extruder prior to the initiation of a print file. The heating of the bed and syringe were not used for the 3D printing of CSBP in this study. Every characterization performed in this study, except for release kinetics, microneedles and packaging application studies, was done by 3D printing CSBP samples at 18 Ga.

FIG. 3 illustrates the CSBP paste after the addition of all the formulation components and heat curing.

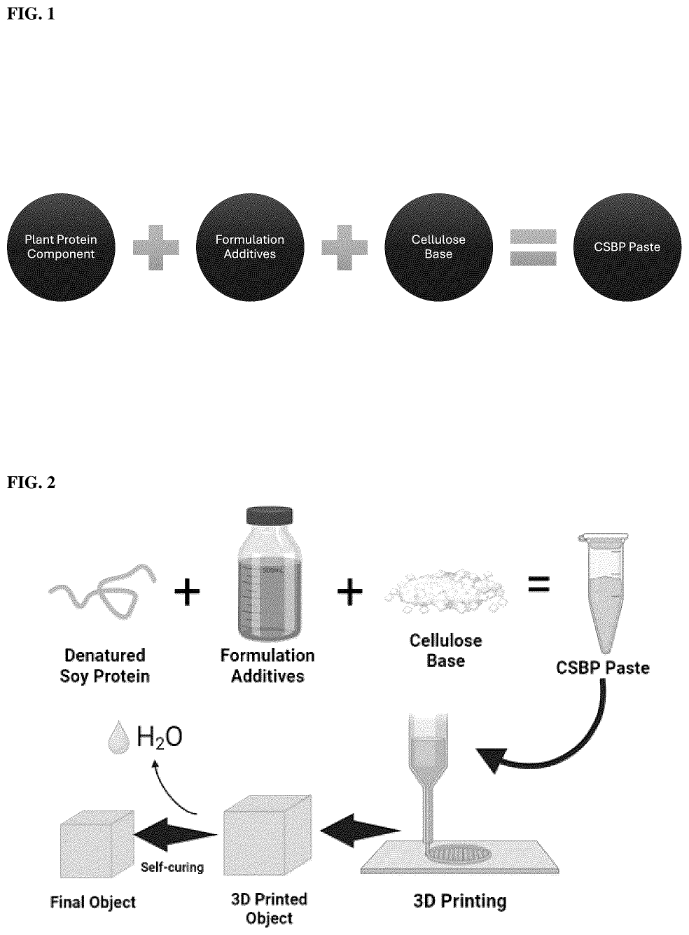

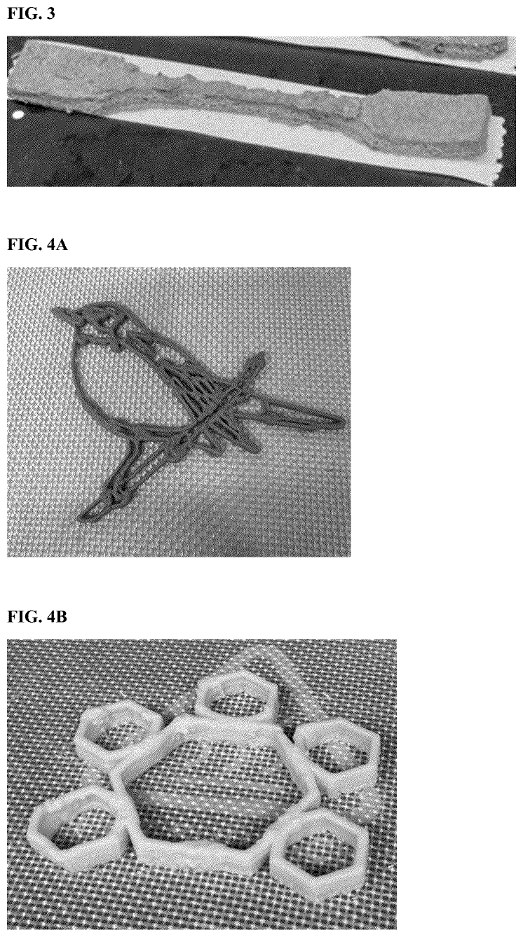

FIGS. 4A and 4B The resulting cellulose-based soy biopolymer (CSBP) formulation can be prepared as above (See FIGS. 1 and 2), and demonstrates good 3D printability, including with a syringe-based mechanism. Compression, tensile and flexural strength are characterized along with biodegradability and cytotoxicity of CSBP.

### Scanning Electron Microscopy

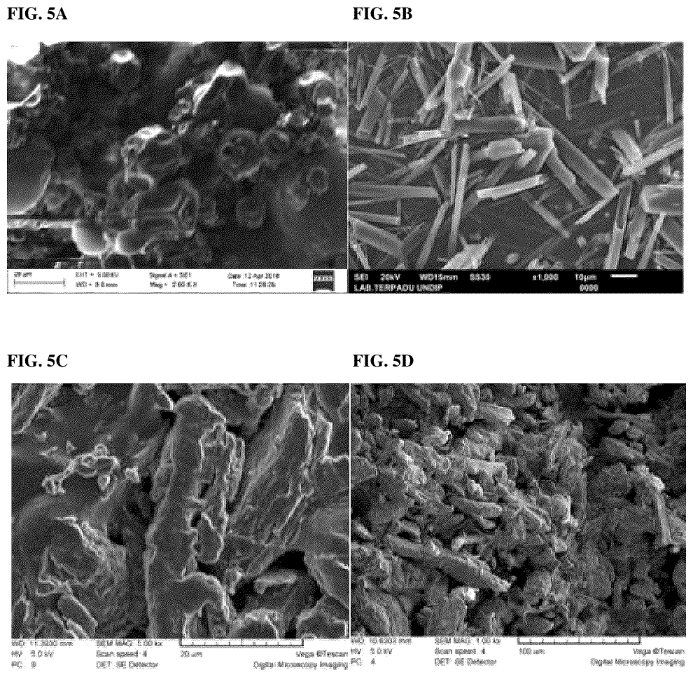

Scanning Electron Microscope Imagery was performed. Images were taken of the surface of 14 day self-cured 10% RH CSBP samples using a Tescan VEGA TS-5130. SEM of the topology of raw soy protein isolate (SPI) shows the protein to have an amorphous shape and size (FIG. 5A). SEM of MCC shows the irregular and sharp appearance of MCC fibers (FIG. 5B).

In the SEM images of self-cured CSBP in FIGS. 5C and 5D, there is a noticeable difference in the appearance of SPI when compared to the SEM of raw SPI, due to the addition of MCC as an emulsifier. The MCC (20 μm fiber size) included into the CSBP formulation causes the deposition of SPI throughout each cellulose fiber to form a film. Research conducted by O'Dell et al. on creating SPI adhesives with glass fiber support shows a similar interaction as seen in the SEM of CSBP, as the SPI showed uniform distribution and film formation throughout a glass fiber support. The SEM images of CSBP also show the expected porous structure, a common feature of SPI-based biomaterials.

The SPI-MCC film formation in CSBP helps to reinforce the final CSBP object by decreasing the porosity and increasing mechanical strength through interactions between MCC fibers and soy protein. Several interactions such as hydrogen bonding, imine linkages and ionic attraction can occur between cellulose fibers and the amine groups of SPI, as well as the formation of amide bonds between cellulose and SPI via amidification.

### Rheology.

Rheology was performed on CSBP using a Kinexus Prime ultra+ rheometer. Two formulations optimized for 3D printing, baseline CSBP as described above, and 10% water-diluted CSBP, for 18 Ga and 20 Ga nozzle diameter prints respectively, were tested from 0.1 to 1000 PaS (shear rate). The diluted CSBP shows weaker resulting mechanical properties, however, it has increased precision for 3D printing.

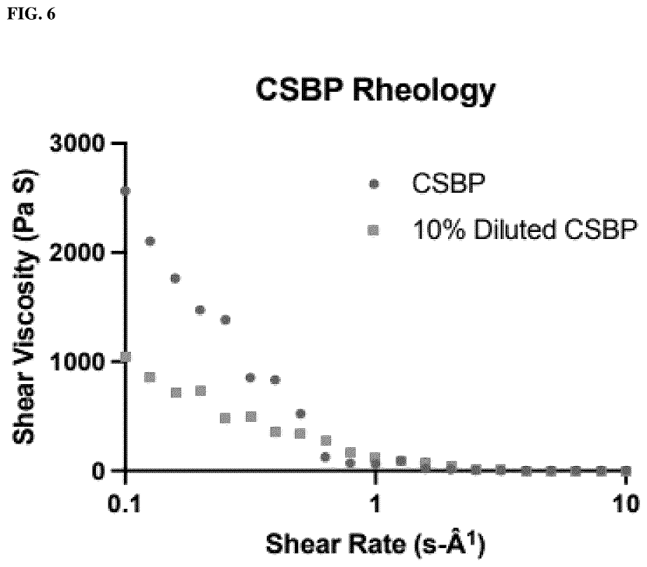

The rheology of CSBP is displayed in FIG. 6, for the base-CSBP formulation as well as the 10% diluted CSBP used in higher quality 3D printing. The results shows that CSBP behaves as a shear-thinning, non-Newtonian fluid which reinforces its suitability for use in a syringe-based 3D printer. With a shear-thinning fluid, viscosity decreases as shear rate increases, meaning the use of a pressure-based system for extrusion allows CSBP to function as a fluid when extruded from a syringe nozzle, whilst maintaining the ability to form solid layers once extruded. As expected, the 10% diluted CSBP formulation shows lower viscosities than the base CSBP formulation at any given shear rate, as the higher ratio of liquid to solid in the formulation decreases the overall viscosity of the paste and increase extrudability.

The material as described herein is capable of printing through a syringe-based 3D printer, and a range of characterizations were performed to evaluate its potential applications. Most importantly, the mechanical properties of CSBP were assessed to determine the strength and limitations of this new material, as well as its performance with different curing conditions. Beyond mechanical properties, properties relating to the sustainability and GRAS nature of this material such as biodegradability and cytotoxicity were evaluated. a universal testing machine (UTM) was used to perform tests for tensile and compressive strength. A CellScale UniVert lkN UTM was used to carry out the following tests.

### Tensile Strength.

To evaluate the tensile strength of self-cured CSBP, tensile bars (50×15×10 mm) of CSBP were 3D printed using a FelixFood 3D printer and self-cured at room temperature (22° C.) and 10% relative humidity (RH) using a desiccator. Two different self-curing time points of 7 days and 14 days were tested for tensile strength, to understand when CSBP becomes fully cured. 24-hour self-cured CSBP could not be evaluated as it is too soft to be held by the tensile grips. Once cured, samples were tested for tensile strength using a CellScale UniVert mechanical tester at a rate of 2.50 mm/min. The tensile strength of heat cured CSBP was also evaluated in addition to self-curing. CSBP tensile bars (50×15×5 mm) were 3D printed and allowed to cure at 10% RH for 24 hours before being heat cured at 200° C. for 30 minutes. Heat cured CSBP samples were tested using a CellScale UniVert at a rate of 2.50 mm/min.

The tensile strength of heat cured CSBP was also evaluated in addition to self-curing. CSBP tensile bars (50×15×5 mm) were 3D printed and allowed to cure at 10% RH for 24 hours before being heat cured at 200° C. for 30 minutes. Heat cured CSBP samples were tested using a CellScale UniVert at a rate of 2.50 mm/min.

The tensile strength of CSBP was recorded for two different time points of self-curing (7 days, 14 days) as well as two different humidities (10% and 55% RH). These humidity values were selected to represent the two humidities that are common indoors throughout the year, as winter humidity stayed constant at 10% while summer humidity values ranged from 50 to 60%. Evaluating self-cured CSBP mechanical strength as a function of RH will help to evaluate how atmospheric water content may impact the mechanical properties of CSBP, as soy-based materials are known to have poor water resistance and thus are often processed using heat.

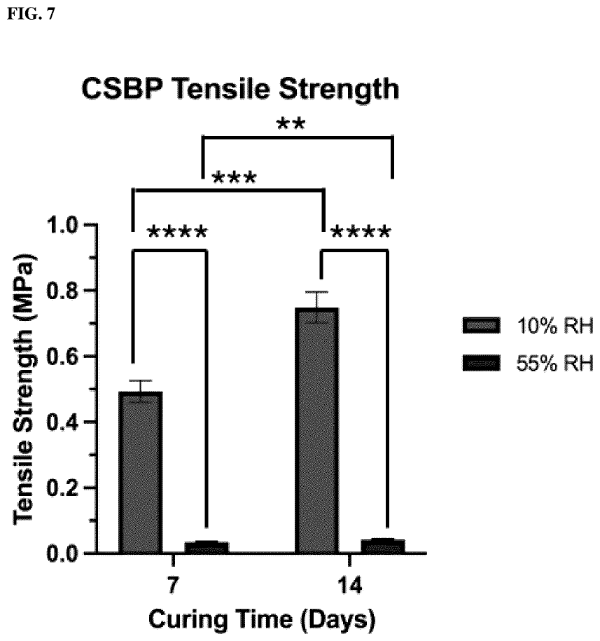

The results shown in FIG. 7 indicate that CSBP has a much greater tensile strength after 7 days of self-curing at 10% RH when compared to 7 days of self-curing 55% RH, and this trend is consistent with the 14-day self-curing data. When preparing and handling the samples, there was a distinct difference between the 10% RH and 55% RH samples—samples cured at 55% RH were much softer and pulled apart with minimal force while the 10% RH samples were much firmer. Tensile data was also recorded for 21 days of self-curing and there was no noticeable difference in the results.

### Compressive Strength.

To evaluate the compressive strength of self-cured CSBP, two different conditions were considered, 10% and 55% RH. CSBP compression samples adhering to the dimensions listed in ASTM D695 (12.7×12.7×25.4 mm) were 3D printed using a FelixFood 3D printer and self-cured at room temperature (22° C.), and either 10% or 55% RH using a desiccator (10% RH) or environmental chamber (55% RH). Three different self-curing time points of 24 hours, 7 days and 14 days were tested for compressive strength. Once cured, samples were tested using a CellScale UniVert mechanical tester for 10% and 35% deformation over a course of 90 seconds.

The compressive strength of heat cured CSBP was also evaluated. CSBP compression samples were 3D printed and allowed to cure at room temperature, 10% RH for 24 hours before being heat cured at 200° C. for 30 minutes. The heat cured CSBP samples were tested according to the procedure outlined in ASTM D695.

Since the self-curing of CSBP produces a non-rigid material with compressibility and recovery, compression was evaluated by looking at the compressive strength at 10% and 35% deformation. ASTM D695 is not suitable for non-rigid materials as failure becomes difficult to accurately define, thus deformation testing is a much better indication of CSBP's compressive properties. Three different self-curing time points of 24 hours, 7 days and 14 days were tested for compressive strength, to understand when CSBP becomes fully cured.

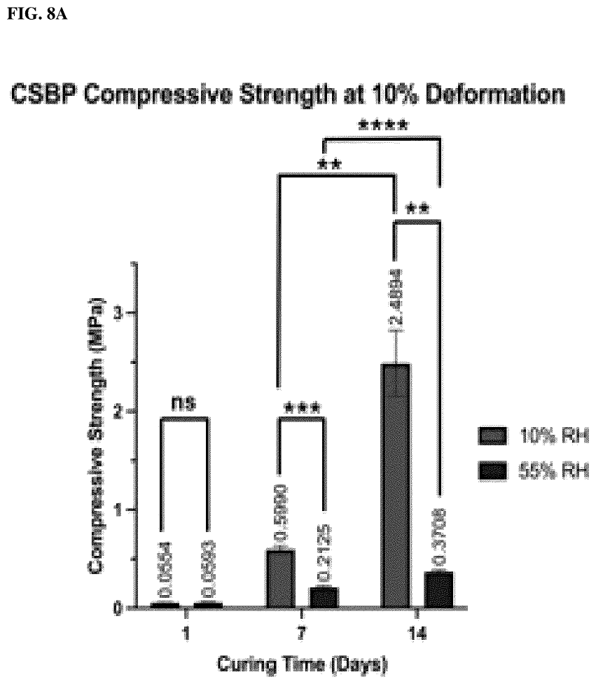

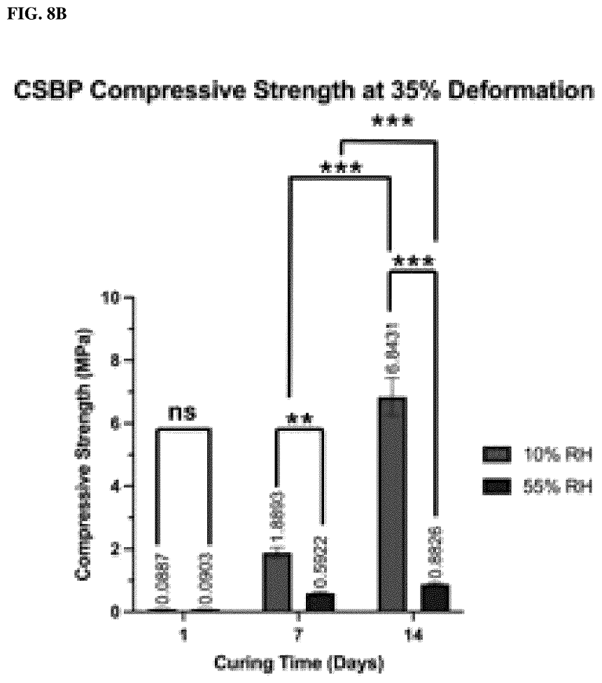

A comparison of CSBP self-cured compressive strength in FIGS. 8A and 8B show that CSBP has the greatest compressive strength at 35% deformation of 6.843+/−0.608 MPa after 14 days of self-curing at 10% RH.

### CSBP Biodegradability in Soil

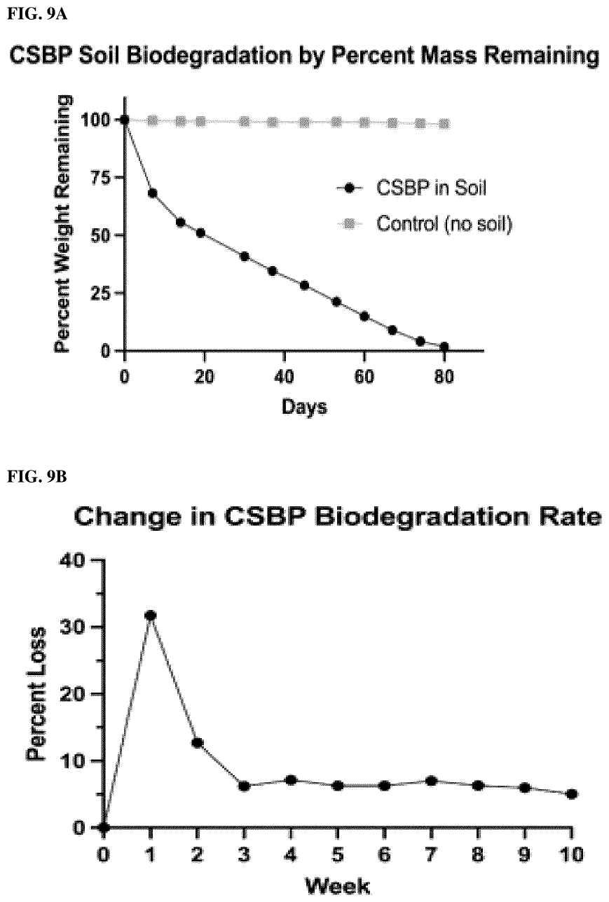

The soil biodegradation of CSBP was conducted using a soil burial test, a technique most commonly used for biomaterial degradation testing (FIGS. 9A and 9B). 15×15×5 mm samples of CSBP were 3D printed using a FelixFood 3D printer and self-cured at room temperature (22° C.), 10% RH for 14 days. After self-curing was complete, samples were dried using a vacuum drying oven, weighed to obtain an initial weight, and buried (5 cm depth) in jars containing fresh samples of soil obtained from Victoria Park in Kitchener, Ontario and kept at room temperature (22° C.), 60% RH. Weekly, CSBP samples were removed from soil, brushed, and dried for 24 hours prior to obtaining weights. After the weights were obtained, samples were re-buried into fresh soil samples. Soil biodegradation was recorded weekly until the sample could no longer be found in the soil. A negative control containing CSBP without soil as well as ABS and PLA were also evaluated alongside CSBP as a comparison.

From the soil burial test conducted, self-cured CSBP lost 98.13+/−0.63% of its weight in 80 days, compared to 1.76+/−0.057% for the negative control (no soil). The slight decrease of self-cured CSBP's weight in the negative control is likely the result of additional weight loss due to self-curing that took place beyond 14 days, or, due to slight degradation because of the conditioning of the samples (22° C., 60% RH).

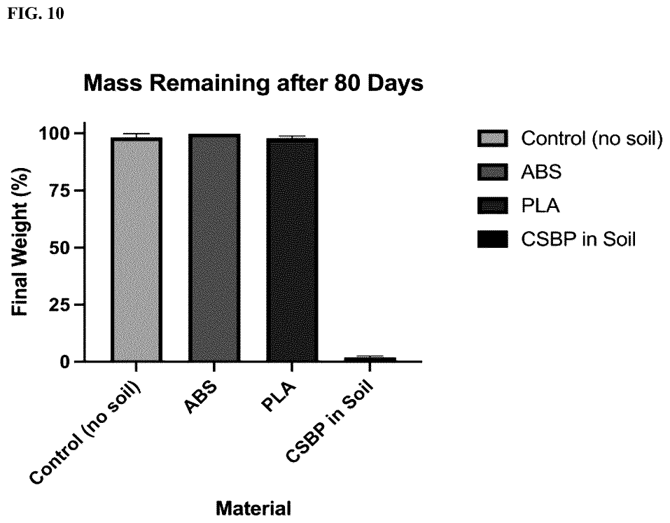

Through a comparison of the soil biodegradation of CSBP to other commonly used thermoplastics in AM, ABS and PLA, CSBP (FIG. 10) is the only sample to show a significant loss in weight. ABS is not biodegradable and the biodegradability of PLA is reliant on highly controlled composting parameters, which reinforces this result.

### Heat Versus Self-Cure Mechanical Properties

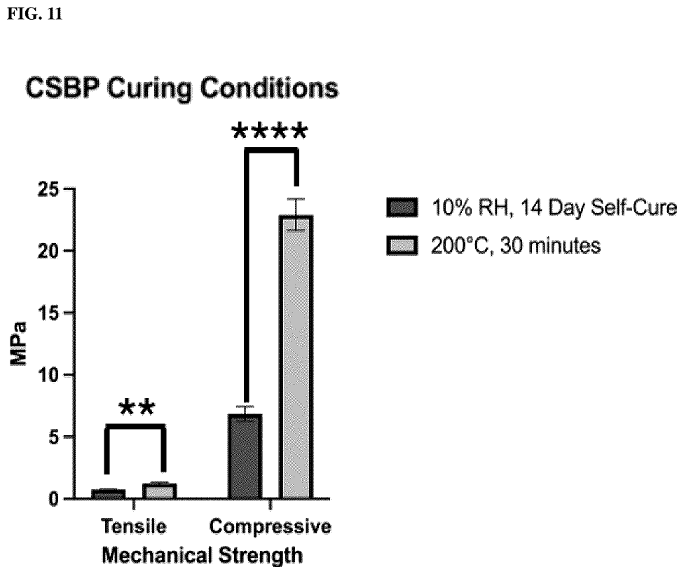

CSBP can be cured with the use of heat opposed to allowing it to self-cure, however, this drastically alters both the resulting material and interactions within CSBP (FIG. 11). Mechanical property testing conducted on heat cured CSBP show a compressive strength of 22.9006+/−1.2881 MPa, and an ultimate tensile strength of 1.235+/−0.11 MPa. Since soy protein plastics are known to be brittle and have low ductility when processed at high temperatures, the tensile strength was determined using ASTM D638 which is designed for rigid plastics. Heat cured CSBP produces a much more rigid and brittle final object compared to self-cured CSBP. A comparison of self-cured and heat cured CSBP mechanical properties is provided in FIG. 11, using the 10% 14-day self-cured CSBP results to represent self-curing.

A comparison of self-cured and heat cured CSBP shows that the use of Maillard-type reactions and crosslinking produces an object with stronger mechanical properties than that of self-cured CSBP. As heat cured CSBP is processed above the thermal degradation of the two additives glycerol and citric acid, it does not rely on these formulation components directly and instead induces Maillard-type reactions between SPI, MCC, and potentially degradation products. Although the tensile strength values of CSBP for self-curing (0.749+/−0.047 MPa) is similar to that of heat cured CSBP (1.235+/−0.11 MPa), the behavior varies significantly. Heat cured CSBP is much firmer and more brittle than self-cured CSBP, and snaps quickly under load. Self-cured CSBP is instead more viscoelastic and has a greater degree of elasticity and resilience than heat cured CSBP.

### Water Properties

Water uptake was evaluated to determine how much water CSBP absorbs when saturated. To do this, CSBP samples (15×15×5 mm) were 3D printed using a FelixFood 3D Printer and self-cured at 10% RH and room temperature (22° C.) for 14 days. In total, 2 different conditions were evaluated for the impact of curing conditions on CSBP water uptake: self-cured CSBP (10% RH, room temperature), 200° C. heat cure for 30 minutes and a thin carnauba wax coating on CSBP to represent a negative control. After the samples were conditioned, they were placed in a room temperature (22° C.), 95% RH environment using a Thermo Forma Environmental Chamber 3911 for 24 hours. After 24 hours at 95% RH, the weight of each CSBP sample was taken. Water contact angle was conducted using a Rame-Hart 190 Contact Angle Goniometer. CSBP samples (15×15×5 mm) were 3D printed using a FelixFood 3D Printer and self-cured at 10% RH and room temperature (22° C.) for 14 days. CSBP samples were then evaluated for their water contact angle. Heat-cured CSBP samples were prepared and tested by heating the self-cured CSBP samples in a 200° C. lab oven for 30 minutes before water contact analysis. Samples were positioned on the stage of the goniometer and a drop of DI water was placed upon the surface to examine the angle between the surface of CSBP and the droplet.

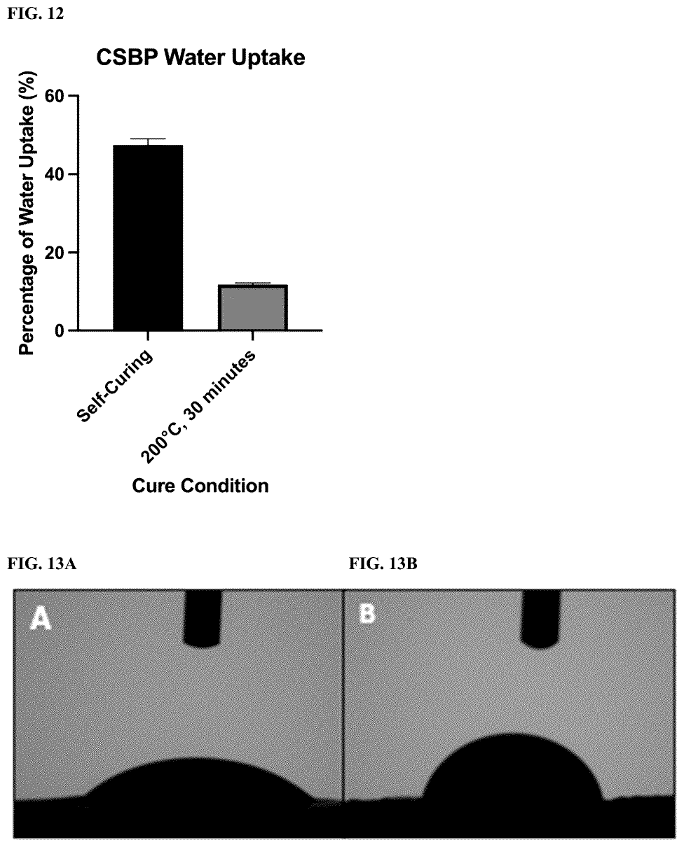

The water properties of CSBP were evaluated by looking at both its water uptake and contact angle, to quantify the water resistance of CSBP with different curing temperatures. The water properties of self-cured CSBP were only evaluated for 14-day, 10% RH self-cured CSBP and referred to as “Self-Curing” in the resulting figures to represent fully self-cured CSBP's water properties. Results of water uptake studies (FIG. 12) showed that CSBP has a higher water uptake of 47.49+/−1.55% compared to that of heat cured (200° C., 30 minutes) CSBP at 11.73+/−0.46%.

The water uptake of CSBP demonstrates the known impact of heat-curing on the resulting water resistance of SPI-based materials as previous studies have successfully used heat-based processes to effectively increase water resistance. The porous structure of CSBP as shown in the SEM contributes to the water uptake of self-cured CSBP. The heat curing of CSBP shows a significantly lower water uptake than self-cured CSBP, which can firstly be attributed to the thermal degradation of two hygroscopic additives, citric acid and glycerol.

The water contact angle results of self-cured and heat cured CSBP reinforce the water uptake results, as self-cured CSBP has a water contact angle of 23.60+/−2.09° and heat cured CSBP has a higher contact angle of 74.87+/−5.76° (FIGS. 13A and 13B). This indicates that although CSBP remains hydrophilic regardless of curing conditions since both contact angles are below 90°, heat cured CSBP is less hydrophilic than self-cured CSBP.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein without any additional undue experimentation. It being understood that various changes may be made in the function and arrangement of elements described in an exemplary embodiment without departing from the scope of the various embodiments as set forth in the appended claims. In particular, a vast number of additional R groups other than the exemplary ones disclosed are expressly contemplated as compatible with one or more embodiments of the disclosure.

Since certain changes may be made in the above-described disclosure, without departing from the spirit and scope of the disclosure herein involved, it is intended that all of the subject matter of the above description shown in the accompanying drawings shall be interpreted merely as examples illustrating the inventive concept herein and shall not be construed as limiting the invention.

Finally, the written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A bio-based curable material comprising a plant-derived protein, an additive, and a cellulose, wherein the material is capable of curing, either through heat or at room temperature, to produce a solid object.

2. The material of claim 1, wherein the plant-derived protein comprises a soy protein source including at least one of soy flour, defatted soy flour, soy concentrate, soy protein isolate (SPI) or a combination thereof.

3. The material of claim 2, wherein the soy protein source comprises from about 40 wt % to about 90 wt % protein.

4. The material of claim 3, wherein the soy protein source is mixed with water to form a soy protein solution at from about 10% w/v to about 30% w/v.

5. The material of claim 4, wherein the soy protein solution is about 20% w/v.

6. The material of claim 4, wherein the soy protein is denatured by heating the soy protein solution to about 700° C. to about 90° C. for at least about 10 minutes (e.g., about 10 minutes to about 360 minutes, about 15 minutes to about 60 minutes, or about 20 minutes).

7. The material of claim 1, wherein the plant-derived protein is crosslinked.

8. The material of claim 1, wherein the additive comprises at least one of a cross-linking agent, a plasticizer or a combination thereof.

9. The material of claim 8, wherein the cross-linking agent has at least one of a hydroxyl group, a carboxyl group or a combination thereof.

10. The material of claim 8, wherein the cross-linking agent is citric acid.

11. The material of claim 8, wherein the cross-linking agent is mixed with water to form an additive solution with cross-linking agent at from about 15% w/v to about 70% w/v.

12. The material of claim 10, wherein the citric acid is mixed with water to form an additive solution comprising citric acid at from about 50% w/v to about 70% w/v.

13. The material of claim 12, wherein additive solution comprises citric acid at about 60% w/v.

14. The material of claim 8, wherein the cross-linking agent is glycerol.

15. The material of claim 14, wherein the glycerol is mixed with water to form an additive solution comprising glycerol at from about 15% w/v to about 35% w/v.

16. The material of claim 15, wherein the additive solution comprises glycerol at about 25% w/v.

17. The material of claim 8, wherein the plasticizer is mixed with water to form an additive solution comprising plasticizer at from about 5% w/v to about 15 w/v.

18. The material of claim 17, wherein the plasticizer is an ethylene glycol-based compound.

19. The material of claim 17, wherein the ethylene glycol-based compound comprises at least one of an ethylene glycol, triacetin, triethylene glycol, a polyethylene glycol or a combination thereof.

20. The material of claim 1, wherein the material comprises a ratio of plant-derived protein to additive of about 1:1.2.

21. The material of claim 1, wherein the cellulose comprises paper fibers, paper pulp, microcrystalline cellulose or a combination thereof.

22. The material of claim 1, wherein the material comprises a ratio of plant-derived protein to cellulose of about 1:2 to about 1:5.

23. A method of making a bio-based curable material comprising:
a. preparing a plant-derived protein solution
b. preparing an additive solution
c. preparing a cellulose solution
d. combining (a)-(c) to form a final binder solution.

24. The method of claim 23, wherein the step of preparing the plant-derived protein solution comprises mixing a plant-derived protein and water to form a plant-derived protein solution at from about 10% w/v to about 30% w/v.

25. The method of claim 24, wherein the plant-derived protein is soy protein.

26. The method of claim 25, wherein the soy protein comprises at least one of soy flour, defatted soy flour, soy concentrate, soy protein isolate (SPI) or a combination thereof.

27. The method of claim 23, wherein the step of preparing an additive solution comprises mixing at least one of a cross-linking agent, a plasticizer or a combination thereof with water to form an additive solution.

28. The method of claim 27, wherein the cross-linking agent is present in an amount of from about 15% w/v to about 70% w/v.

29. The method of claim 28, wherein the cross-linking agent has at least one of a hydroxyl group, a carboxyl group or a combination thereof.

30. The method of claim 28, wherein the cross-linking agent is citric acid.

31. The method of claim 30, wherein the citric acid is present in an amount of from about 50% w/v to about 70% w/v.

32. The method of claim 30, wherein the citric acid is present in an amount of about 60% w/v.

33. The method of claim 28, wherein the cross-linking agent is glycerol.

34. The method of claim 14, wherein the glycerol is present in an amount of from about 15% w/v to about 350% w/v.

35. The method of claim 15, wherein the glycerol is present in an amount of about 25% w/v.

36. The method of claim 27, wherein the plasticizer is present at an amount of from about 5% w/v to about 15 w/v.

37. The method of claim 36, wherein the plasticizer is an ethylene glycol-based compound.

38. The method of claim 37, wherein the ethylene glycol-based compound comprises at least one of an ethylene glycol, triacetin, triethylene glycol, a polyethylene glycol or a combination thereof.

39. The method of claim 23, wherein the material comprises a ratio of plant-derived protein solution to additive solution of about 1:1.2.

40. The method of claim 23, wherein the material comprises a ratio of plant-derived protein solution to cellulose solution of about 1:2 to about 1:5.

41. The method of claim 23, further comprising a step of 3D printing or extruding the material and optionally curing with heat or an enzyme.
